(19) United States
(12) Patent Application Publication
(10) Pub. No.: US 2018/0365779 A1
(43) Pub. Date: Dec. 20, 2018

(54) ADMINISTERING PRE-TRIAL JUDICIAL SERVICES

(71) Applicant: Global Tel*Link Corporation, Reston, VA (US)

(72) Inventor: Stephen Lee Hodge, Aubrey, TX (US)

(21) Appl. No.: 15/622,901

(22) Filed: Jun. 14, 2017

(51) Int. Cl. G06Q 50/18; G10L 15/26; G06F 17/28; G06F 3/16; H04N 5/77; G06F 17/22; G06Q 50/26; G06F 17/30

(52) U.S. Cl. CPC G06Q 50/18; G10L 15/265; G06F 17/289; G06F 17/30778; H04N 5/77; G06F 17/2211; G06Q 50/26; G06F 3/167

(57) ABSTRACT

Disclosed herein are system, method, and computer program product embodiments for administering pre-trial judicial services. In an embodiment, a verification management system may verify information given by an offender during an interview. The verification management system may use audio and/or image processing to compare responses given by an offender to information stored in a jurisdictional database and/or stored on a mobile communication device owned by the offender. In an embodiment, if the offender is released by the judiciary but released subject to conditions, an offender management system may send notifications to the offender's mobile communication device. The offender management system may also collect geographic and/or biometric information from the offender's mobile communication device and/or an offender peripheral device to determine whether the offender is adhering to the release conditions.

### BACKGROUND

The process of judicial intervention with a potential criminal offender begins with a police officer approaching a member of the public. In response to an emergency call, such as a 911 call, or while police officers are patrolling the streets, police officers sometimes interview witnesses or potential offenders of a crime. Police officers also use mobile computers to check jurisdictional database system to determine if an offender is associated with an active arrest warrant. At times, police officers might ask witnesses or offenders suspected of a crime to accompany the police officers to a police station. In other instances, the police officers might institute an arrest of an offender suspected of a crime.

Once an arrest is performed, the offender may be charged and incarcerated to await trial or may be charged and released back into society until the date of the trial. This determination results in a “pre-trial” status for the offender. In order to make the determination between incarceration and release, the judiciary, police officers, and/or pre-trial service agencies perform an interview of the offender, assisting the judge making the pre-trial determination. Often, however, verification of the information provided by the offender is burdensome, especially in real-time. In these cases, misinformation may result, leading to an inappropriate determination of release or incarceration.

Further, even if an offender is released, the judiciary may impose conditions associated with release. For example, in some cases, the judiciary requires the offender to adhere to geographical restrictions, to avoid contacting certain individuals, and/or to maintain employment. Monitoring these pre-trial conditions is often difficult. To encourage adherence to pre-trial release conditions, systems and methods are required to monitor the activities of released offenders.

### BRIEF DESCRIPTION OF THE DRAWINGS

The accompanying drawings are incorporated herein and form a part of the specification.

FIG. 1A illustrates a block diagram of an information evaluation system, according to exemplary embodiments.

FIG. 1B illustrates a block diagram of an information evaluation system highlighting the interview system, according to exemplary embodiments.

FIG. 1C illustrates a block diagram of a hardware configuration system, according to exemplary embodiments.

FIG. 2 illustrates a block diagram of an offender notification and monitoring system, according to exemplary embodiments.

FIG. 3 illustrates a flowchart illustrating a method for real-time interview verification, according to exemplary embodiments.

FIG. 4 illustrates an example computer system useful for implementing various embodiments.

The present disclosure will be described with reference to the accompanying drawings. In the drawings, like reference numbers generally indicate identical or similar elements. Additionally, generally, the left-most digit(s) of a reference number identifies the drawing in which the reference number first appears.

### DETAILED DESCRIPTION

The following Detailed Description refers to accompanying drawings to illustrate exemplary embodiments consistent with the disclosure. References in the Detailed Description to “one exemplary embodiment,” “an exemplary embodiment,” “an example exemplary embodiment,” etc., indicate that the exemplary embodiment described may include a particular feature, structure, or characteristic, but every exemplary embodiment may not necessarily include the particular feature, structure, or characteristic. Moreover, such phrases are not necessarily referring to the same exemplary embodiment. Further, when a particular feature, structure, or characteristic is described in connection with an exemplary embodiment, it is within the knowledge of those skilled in the relevant art(s) to affect such feature, structure, or characteristic in connection with other exemplary embodiments whether or not explicitly described.

The exemplary embodiments described herein are provided for illustrative purposes, and are not limiting. Other exemplary embodiments are possible, and modifications may be made to the exemplary embodiments within the spirit and scope of the disclosure. Therefore, the Detailed Description is not meant to limit the invention. Rather, the scope of the invention is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc. Further, any of the implementation variations may be carried out by a general purpose computer, as described below.

For purposes of this discussion, any reference to the term “module” shall be understood to include at least one of software, firmware, or hardware (such as one or more circuit, microchip, or device, or any combination thereof), and any combination thereof. In addition, it will be understood that each module may include one, or more than one, component within an actual device, and each component that forms a part of the described module may function either cooperatively or independently of any other component forming a part of the module. Conversely, multiple modules described herein may represent a single component within an actual device. Further, components within a module may be in a single device or distributed among multiple devices in a wired or wireless manner.

The following Detailed Description of the exemplary embodiments will so fully reveal the general nature of the invention that others can, by applying knowledge of those skilled in relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

Provided herein are system, apparatus, device, method and/or computer program product embodiments for administering pre-trial judicial services.

In an embodiment, the systems and methods described herein verify information captured during an interview with an offender. To verify the information captured, an interview system captures information such as audio and visual information collected during an interview. The interview system transfers this information to a verification management system for verification of accuracy or truthfulness.

In an embodiment, to verify the provided information, the verification management system converts the audio information into a text format using speech-to-text signal processing. In an embodiment, the verification management system converts the audio information provided by the offender into text for report generation. For example, the offender may provide audio information that the verification management system uses to populate a report of the interview. Additionally, the verification management system analyzes visual information, such as handwriting and/or drawings using optical character recognition and/or image processing algorithms.

For comparison with the analyzed audio and/or visual information, the verification management system receives information from a jurisdictional database and/or from the mobile device of the offender. In an embodiment, the jurisdictional database stores records related to past and/or currently pending criminal investigations, warrants, and/or instances of judicial intervention. In an embodiment, the jurisdictional database includes information local to the jurisdiction where the arrest occurred and/or where the offender's trial is scheduled. In an embodiment, the jurisdictional database interfaces with a national database storing criminal history information, such as, for example, the National Crime Information Center and/or the Interstate Identification Index. The verification management system queries the jurisdictional database for information related to the substance of the interview. These queries may also evolve and/or change as the interview progresses, targeting different information as an offender provides new information. In an embodiment, the verification management system compares the information provided during the interview with the information queried from the database. The verification management system then records any inconsistent statements provided by the offender. The verification management system also reports the inconsistencies in real-time to a law enforcement agent and/or a pre-trial service administrator, allowing for near-instant notification that the offender has provided false information. In an embodiment, if the offender has provided false information, the verification management system stores a record of the falsehood.

In an embodiment, the verification management system interfaces with a hardware configuration system to interface with a mobile communication device owned by the offender. The mobile communication device may be, for example, a phone, tablet, laptop computer, and/or other electronic devices with communication functionality. In an embodiment, the offender provides consent to access the mobile communication device orally and/or via a written consent form. Granting access to the mobile communication device in this manner may ensure that the offender's Fourth Amendment rights are not violated. Offenders are further encouraged to provide this consent as verification of information provided during an interview aids in the determination that the judiciary should release the offender prior to trial.

In an embodiment, the verification management system accesses the mobile communication device to verify information, such as phone numbers, addresses, and/or other contact information. The verification management system also accesses text messages and/or phone logs to verify information provided by the offender. In an embodiment, the verification management system and/or hardware configuration system maintains confidentiality over the content of the mobile communication device. For example, the verification management system compares the information provided by the offender to the information stored on the offender's mobile communication device without allowing a law enforcement agent and/or a pre-trial service administrator to read the content of the mobile communication device. In this case, the verification management system reveals that an inconsistency exists without necessarily revealing the content of the mobile communication device. As a result, law enforcement agents and/or pre-trial service administrators may verify information stored in the mobile communication device without the need to personally read the contents. This embodiment allows for the verification of information while carefully complying with Fourth Amendment search and seizure rights.

In an embodiment, the verification management system accesses the offender's mobile communication device to initiate phone calls with contacts listed in a contact list stored on the mobile communication device. The verification management system allows a law enforcement agent and/or a pre-trial service administrator to perform phone calls with the contacts and/or initiate interactive voice response menus to verify information provided by the offender. The verification management system may also translate the interactive voice response menus into different languages to aid with verification. In an embodiment, the verification management system verifies the identity of the called party using caller identification but hides the actual phone number and/or contact information from law enforcement agents and/or pre-trial service administrators to preserve the privacy of the content of the offender's mobile communication device.

Based on the information received from the offender's mobile communication device and from jurisdictional databases, in an embodiment, the verification management system determines if the offender is providing false information during the interview. By comparing the offered information with information stored in the offender's mobile communication device or from the jurisdictional database, the verification management system identifies discrepancies between the proffered interview information and the stored information. The verification management system indicates these discrepancies to the interviewer and/or compile these discrepancies in a report. In an embodiment, the verification management system stores this report in a database, such as, for example, an internal memory device and/or the jurisdictional database, to notify the judiciary of discrepancies. This information may aid the judiciary in determining whether the offender should be released or incarcerated until trial.

In some cases, pre-trial service agencies may not recommend offenders for release unless the information obtain during the interview is verified. The verification management system aids in this verification. In some embodiments, the verification management system also provides notifications when the offender is providing truthful information and/or may generate a report indicating the absence of discrepancies. The verification management system also indicates how and/or why certain offender statements have been confirmed as true. Based on the aggregation of the verified information, law enforcement and/or pre-trial service agencies may develop a risk assessment, determining, for example, an offender's risk of danger to the community and/or likelihood of appearing in court on the offender's date of trial. In an embodiment, the verification management system generates a recommendation automatically based on the verified information. The verification management system calculates a risk assessment score based on parameters set by the law enforcement and/or pre-trial service agency. Using this risk assessment score along with a report of verified information, the pre-trial service agency may generate a recommendation to the court for either release or incarceration of the offender.

In an embodiment, the judiciary may decide to release the offender until trial. In some cases, however, the judiciary additionally imposes conditions and/or restrictions on the offender. For example, the judiciary generates restrictions based on geography (e.g., the offender may not enter a geographic location and/or the offender is restricted to only certain locations), maintaining a curfew, and/or requiring regular drug testing. To encourage adherence to these conditions, in some embodiments, the offender's mobile communication device is modified.

In an embodiment, verification management system utilizes a hardware configuration system to modify properties of the offender's mobile communication device. In an embodiment, the hardware configuration system resides separate from the verification management system. With consent from the offender, the hardware configuration system modifies the mobile communication device to include information such as court date reminders and/or notifications when an offender violates a condition.

The hardware configuration system also modifies the mobile communication device to provide information to an offender management system. The offender management system monitors offenders who have opted to participate in release monitoring. The offender management system receives information such as, for example, global position system (GPS) information. In an embodiment, the hardware configuration system restricts the mobile communication device, locking certain features, such as, for example, the ability to call or to be called by specified parties using the mobile communication device. While this restriction may not completely prevent communications with blocked parties, impeding phone calls using the mobile communication device may deter some calls from occurring. In an embodiment, with the consent of the offender, the offender management system may be able to listen to phone calls or audio information of the mobile communication device.

In an embodiment, the hardware configuration system configures the offender's mobile communication device to allow the offender management system to periodically send “check-in” notifications to the offender. For example, in an embodiment, the offender management system requires the offender to take a picture showing the offender's face and/or provide a voiceprint for verification. In an embodiment, this check-in requirement is unannounced and provides the offender with a preset amount of time in which the offender must respond. If the offender does not respond within the preset amount of time, the offender management system generates an alert and/or informs the judiciary of the noncompliance. These check-ins help to ensure that the offender maintains possession of the offender's mobile communication device. In an embodiment, the offender management system utilizes other biometric features to verify the identity of the offender.

In an embodiment, the hardware configuration system also interfaces with an offender peripheral device. In some instances, rather than returning an offender's mobile communication device, the judiciary requires the offender to relinquish the offender's mobile communication device and issue a new, law enforcement-issued phone to the offender pending trial. In this embodiment, the hardware configuration system configures the law enforcement-issued phone with certain features. For example, the hardware configuration system routes phone calls intended for the offender's mobile communication device to the law enforcement-issued phone. In an embodiment, the hardware configuration system copies some information, such as, for example, contacts, from the offender's mobile communication device onto the law enforcement-issued phone.

In an embodiment, the hardware configuration system interfaces with a wearable device, such as, for example, a device semi-permanently attachable to an offender's wrist or ankle. This wearable device communicates with the offender's mobile communication device and/or directly with the offender management system. In an embodiment, the offender management system requires the wearable device to be in close proximity to the offender's mobile communication device, preventing the offender from relinquishing control of the mobile communication device. In an embodiment, the wearable devices includes a biometric sensor. In an embodiment, the biometric sensor detects low concentrations of alcohol secreted through the skin and determine how much alcohol has been consumed. The biometric sensor determines a measurement of blood alcohol content. The wearable device and/or the offender's mobile communication device reports results over a certain threshold to the offender management system.

In an embodiment, the wearable device is an electronic device inserted just below the surface of the skin. The subcutaneous device provides continuous sampling and diagnostics related to substance abuse. In an embodiment, the mobile communication device interfaces with the subcutaneous device and reports measurements associated with the offender's biological state to the offender management system. Combining the functionality of mobile communication devices with the wearable device better informs the judiciary regarding compliance with release conditions and further encourages offenders to adhere to the conditions.

Although this disclosure describes some embodiments related to interviewing potential criminal offenders, the systems described herein may also be utilized in other information verification contexts, such as, for example, job interviews and/or background checks. The systems described herein may also be utilized in other monitoring embodiments, such as, for example, monitoring health care patients. National and/or state-wide databases may be accessed to retrieve patient-related information.

These features will now be discussed with respect to the corresponding figures.

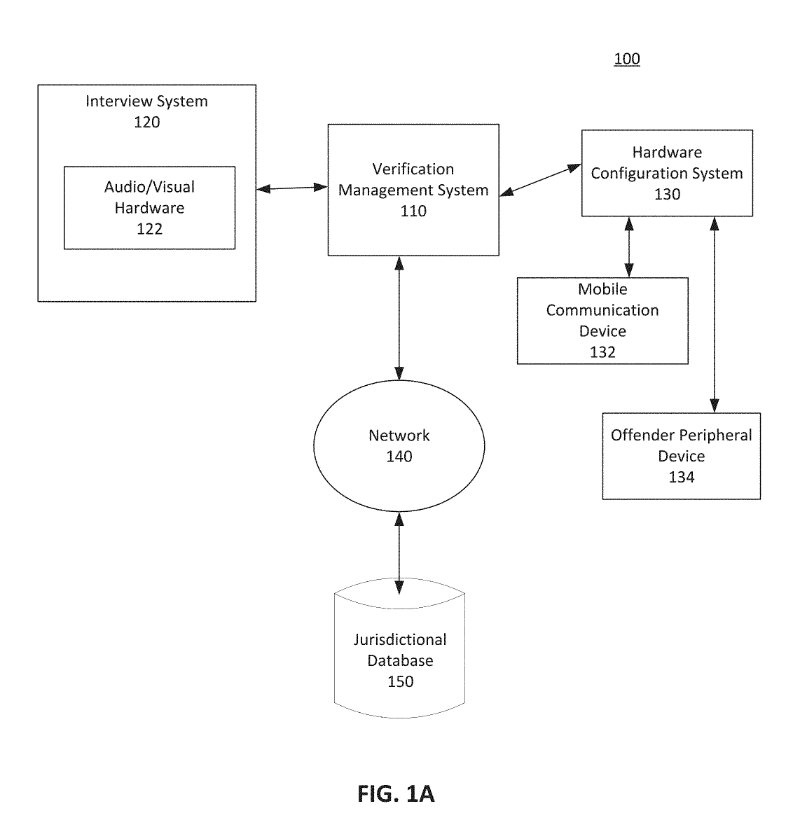

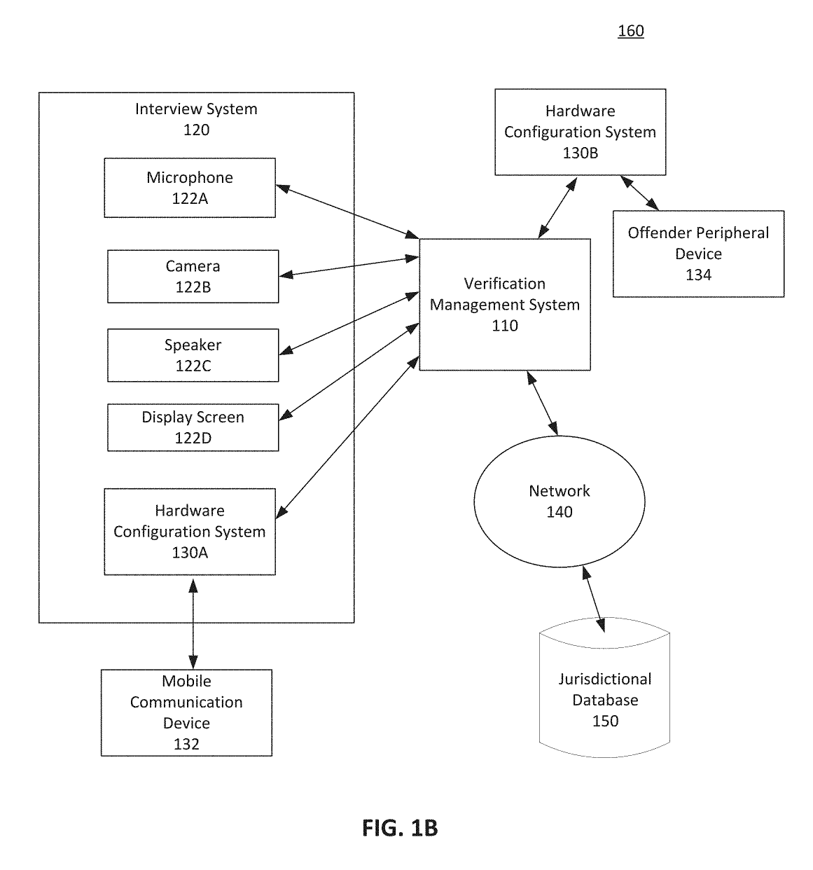

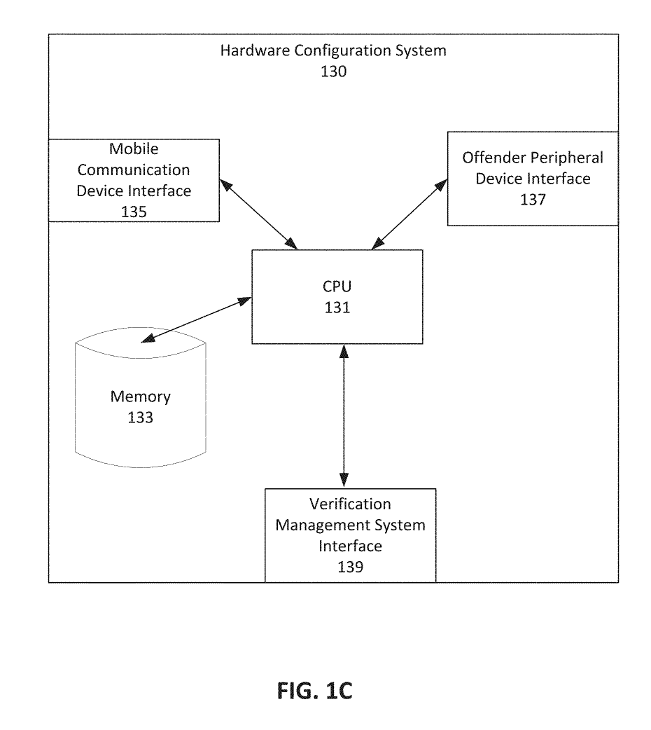

FIG. 1A illustrates a block diagram of an information evaluation system 100, according to exemplary embodiments. In an embodiment, information evaluation system 100 includes a verification management system 110, an interview system 120, a hardware configuration system 130, a network 140, and a jurisdictional database 150.

In an embodiment, verification management system 110 includes one or more processors, memory, servers, routers, modems, and/or antennae configured to interface with interview system 120, hardware configuration system 130, and/or jurisdictional database 150. To interface with jurisdictional database 150, verification management system 110 utilizes network 140 and/or a network protocol to send and receive data over network 140. In an embodiment, network 140 is a network capable of transmitting information either in a wired or wireless manner and may be, for example, the Internet, a Local Area Network, or a Wide Area Network. The network protocol may be, for example, a hypertext transfer protocol (HTTP), a TCP/IP protocol, Ethernet, cellular, Bluetooth, or an asynchronous transfer mode, to name just a few examples, or any combination thereof. In an embodiment, verification management system 110 also utilizes network 140 to communicate with interview system 120 and hardware configuration system 130. In an embodiment, interview system 120 and/or hardware configuration system 130 share hardware, such as, for example, processors, memory, and/or circuitry with verification management system 110.

In an embodiment, verification management system 110 interfaces with interview system 120. Interview system 120 includes one or more processors, memory, servers, routers, modems, antennae, and/or circuitry configured to interface with verification management system 110. Interview system 120 also includes equipment used to interview an offender, including, for example, audio/visual hardware 122. As further described with reference to FIG. 1B, in an embodiment, audio/visual hardware 122 includes, for example, a microphone, camera, speakers, amplifiers, audio signal and/or image processors, computer input peripherals, a keyboard, a mouse, a polygraph machine, biometric sensors, and/or other equipment used to record information provided by an offender. During an interview of an offender, a law enforcement agent and/or a pre-trial service administrator may utilize interview system 120 to interview an offender. In an embodiment, interview system 120 collects information relevant to, for example, the offender's address, community ties, employment status, medical history, history of substance abuse, mental health issues, and/or other information relevant to the determination of whether the offender should be released or incarcerated pending trial.

Interview system 120 collects the offender information and sends the information to verification management system 110. In an embodiment, interview system 120 processes data gathered, such as, for example, converting spoken answers into a text format using a microphone and speech-to-text processing. In an embodiment, interview system 120 analyzes visual information provided by the offender, such as, for example, drawings or writing. In an embodiment, interview system 120 transmits raw interview data to verification management system 110. In an embodiment, interview system 120 processes the collected interview data and transmits the processed data to verification management system 110.

In an embodiment, interview system 120 utilizes an interactive voice recording and voice prompt menu to perform the interview. Interview system 120 modifies questions asked based on the verification of answers provided by the offender. The voice prompt menu also includes different languages. This feature allows interview system 120 to gather information from the offender in the offender's preferred language. This embodiment further allows for an interview to occur without a law enforcement agent and/or a pre-trial service administrator needing to speak a language understood by the offender. In an embodiment, to facilitate a conversation between an offender and a law enforcement agent and/or a pre-trial service administrator, interview system 120 includes two-way, real-time voice translation software and/or hardware. Interview system 120 translates questions asked and answers provided by the offender. This real-time translation aids in the facilitation of live interviews.

In an embodiment, software that converts speech to text reduces the time needed to complete an interview and recording the provided information. For example, in an embodiment, a law enforcement agent and/or a pre-trial service administrator may ask an offender for the offender's address. Interview system 120 records the response using speech-to-text processes and may populate an “address” section of an interview report. In an embodiment, a law enforcement agent and/or a pre-trial service administrator may be able to override responses based on errors or when follow-up questioning is needed. In an embodiment, interview system 120 transmits responses to verification management system 110. Verification management system 110 then generates a report and/or stores the response in a memory device, such as, for example, a database and/or a hard disk drive internal and/or external to verification management system 110. This process results in the recordation of responses provided by the offender in an interview.

In an embodiment, verification management system 110 verifies the truth and/or authenticity of responses provided by the offender. To verify responses received at interview system 120, verification management system 110 interfaces with jurisdictional database 150 and/or hardware configuration system 130.

In an embodiment, jurisdictional database 150 is a database local to the jurisdiction within which the pre-trial interview occurs. For example, jurisdictional database 150 is connected to a local police station, judiciary, pre-trial service agency, and/or other databases storing criminal history records. In an embodiment, the jurisdictional database is, or interfaces with, a national database storing criminal history information, such as, for example, the National Crime Information Center and/or the Interstate Identification Index.

Jurisdictional database 150 stores records related to past and/or currently pending criminal investigations, warrants, and/or instances of judicial intervention. Jurisdictional database 150 also stores records related to past pre-trial interviews. In an embodiment, verification management system 110 queries jurisdictional database 150 for information related to the substance of the interview, such as, for example, to verify a response given by the offender. These queries also evolve and/or change to request different information as the interview progresses. In an embodiment, verification management system 110 compares the information provided during the interview with the information queried from jurisdictional database 150. In an embodiment, this comparison occurs based on the information received from interview system 120. Verification management system 110 then records any inconsistent statements provided by the offender.

In an embodiment, verification management system 110 also reports the inconsistencies in real-time to a law enforcement agent and/or a pre-trial service administrator, allowing for near-instant notification that the offender has provided false information. For example, if a law enforcement agent and/or a pre-trial service administrator is using interview system 120 to conduct an interview with the offender, verification management system 110 sends a notification system to interview system 120 indicating that a response provided was false. For example, in an embodiment, verification management system 110 and/or interview system 120 is equipped with a display screen and a visual alert displays on the display screen. In an embodiment, the display screen displays additional information related to the discrepancy, such as, for example, the information retrieved from jurisdictional database 150 showing that the offender has provided a response inconsistent with previously stored data. In an embodiment, a light illuminates to indicate a falsehood. In an embodiment, verification management system 110 and/or interview system 120 generates an audio alert, such as a noise. In an embodiment, if the offender has provided false information, verification management system 110 stores a record of the falsehood in an internal and/or external memory device.

In an embodiment, verification management system 110 stores responses that verification management system 100 cannot verify. In an embodiment, verification management system 110 generates and/or stores a report and/or transcript of the interview based on the questions asked and/or the responses received. In an embodiment, verification management system 110 stores audio files and/or video files. In an embodiment, verification management system 110 utilizes network 140 to store interview information in jurisdictional database 150.

To illustrate the verification capabilities of verification management system 110, during an interview, an offender may state that the offender has lived at a current address for two years. Interview system 120 captures this response utilizing audio/visual hardware 122. Interview system 120 and/or verification management system 110 then converts a spoken audio response into a text format and/or other binary representations using a speech-to-text processor. Verification management system 110 queries jurisdictional database 150 to verify this statement. In an embodiment, this query includes, for example, a search of the offender name, address provided, and/or other information associated with the potential crime of which the offender may be charged. In an embodiment, verification management system 110 accesses a previous interview conducted with the offender wherein the offender provided a different address six months earlier. Based on this comparison, verification management system 110 records the inconsistent statement and/or alerts a law enforcement agent and/or a pre-trial service administrator to the inconsistent statement. In an embodiment, this alert occurs in real-time as verification management system 110 detects the falsehood. As such, verification management system 110 quickly performs real-time verification, allowing the interviewer to potentially press the question to determine the truth.

In an embodiment, verification management system 110 interfaces with hardware configuration system 130 to verify information, such as phone numbers, addresses, contact information, and/or other information stored on a mobile communication device 132. In an embodiment, mobile communication device 132 is a phone, tablet, laptop computer, and/or other electronic devices with communication functionality. In an embodiment, verification management system 110 also accesses text messages and/or phone logs to verify information provided by the offender. Hardware configuration system 130 includes one or more processors, memory, and/or wired and/or wireless circuitry configured to interface with verification management system 110, mobile communication device 132, and/or offender peripheral device 134. The connection with offender peripheral device 134 will be discussed further with reference to FIG. 1C.

In an embodiment, the circuitry of hardware configuration system 130 includes software configured to access information stored on mobile communication device 132. In an embodiment, mobile communication device 132 belongs to the offender. In an embodiment, the offender provides consent to access mobile communication device 132 orally and/or via a written consent form. Granting access to mobile communication device 132 in this manner ensures that the offender's Fourth Amendment rights are not violated. Offenders are further encouraged to provide this consent as verification of information may aid in the determination that the judiciary should release the offender prior to trial.

In an embodiment, verification management system 110 and/or hardware configuration system 130 maintains confidentiality over the content of mobile communication device 132. For example, verification management system 110 compares the information provided by the offender at interview system 120 to the information stored on the offender's mobile communication device 132 without allowing a law enforcement agent and/or a pre-trial service administrator to read the content of the mobile communication device. In this case, verification management system 110 reveals that an inconsistency exists without necessarily revealing the content of mobile communication device 132. As a result, law enforcement agents and/or pre-trial service administrators are able to verify information stored in mobile communication device 132 without the need to personally read the contents. This embodiment allows for the verification of information while carefully complying with Fourth Amendment search and seizure rights.

In an embodiment, verification management system 110 and/or hardware configuration system 130 locally stores information collected from mobile communication device 132 for a brief period of time. For example, verification management system 110 and/or hardware configuration system 130 stores content from mobile communication device 132 only for the duration of the interview. Verification management system 110 and/or hardware configuration system 130 then deletes the data without providing read access, ensuring confidentiality of the content of mobile communication device 132. In an embodiment, the data is deleted after the interview has concluded.

In an embodiment, verification management system 110 accesses mobile communication device 132 to initiate voice calls and/or text message communications with contacts listed in a contact list stored on mobile communication device 132. Verification management system 110 allows a law enforcement agent and/or a pre-trial service administrator to perform phone calls and/or initiates interactive voice response menus to verify information provided by the offender. In an embodiment, verification management system 110 also translates the interactive voice response menus into different languages to aid with verification. In an embodiment, verification management system 110 verifies the identity of the called party using caller identification but hides the actual phone number and/or contact information from law enforcement agents and/or pre-trial service administrators to preserve the privacy of the content of the offender's mobile communication device 132. In an embodiment, verification management system 110 engages in a text message communication with the contact to verify interview information.

Based on the information received from the offender's mobile communication device 132 and from jurisdictional database 150, verification management system 110 determines if the offender is providing false information during the interview. By comparing the offered information with information stored in the offender's mobile communication device 132 or from jurisdictional database 150, verification management system 110 identifies discrepancies between the proffered interview information and the stored information. Verification management system 110 indicates these discrepancies to the interviewer and/or compile these discrepancies in a report.

In an embodiment, verification management system 110 stores this report in a database, such as, for example, an internal memory device and/or jurisdictional database 150, to notify the judiciary of discrepancies. This information may aid the judiciary in determining whether the offender should be released or incarcerated until trial.

In some cases, pre-trial service agencies will not recommend offenders for release unless the information obtain during the interview is verified. Verification management system 110 aids in this verification. In some embodiments, verification management system 110 also provides notifications when the offender is providing truthful information and/or generates a report indicating the lack of discrepancies. Verification management system 110 also indicates how and/or why certain offender statements have been confirmed as true. For example, verification management system 110 displays information gathered from jurisdictional database 150 verifying the information or, with the consent of the offender, display information gathered from mobile communication device 132. Based on the aggregation of the verified information, law enforcement and/or pre-trial service agencies may develop a risk assessment, determining, for example, an offender's risk of danger to the community and/or likelihood of appearing in court on the offender's date of trial. In an embodiment, verification management system 110 generates a recommendation automatically based on the verified information. In an embodiment, verification management system 110 calculates a risk assessment score based on parameters set by the law enforcement and/or pre-trial service agency. Using this risk assessment score along with a report of verified information, the pre-trial service agency may generate a recommendation to the court for either release or incarceration of the offender.

In an embodiment, verification management system 110 automatically generates an interview report, risk assessment score, and/or a recommendation of release or incarceration. In an embodiment, verification management system 110 generates this information using parameters set by law enforcement agents and/or pre-trial service administrators. In an embodiment, the judiciary specifies the content of the report, score, and/or recommendation and provides a set of judiciary parameters to verification management system 110.

FIG. 1B illustrates a block diagram of an information evaluation system 160 highlighting interview system 120, according to exemplary embodiments. Similar to the embodiment of information evaluation system 100 described with reference to FIG. 1A, information evaluation system 160 includes a verification management system 110, an interview system 120, a network 150, and a jurisdictional database 150. Information evaluation system 160 differs from information evaluation system 100 via the presence of two hardware configuration systems 130A and 130B. The functionality of hardware configuration system 130B and interfacing with offender peripheral device 134 will be discussed further in reference to FIG. 1C.

In an embodiment, interview system 120 includes microphone 122A, camera 122B, speaker 122C, display screen 122D, and hardware configuration system 130A. In an embodiment, interview system 120 operates in a location remote from verification management system 110. Interview system 120 utilizes network 140 or a separate network to interface with verification management system 110. In an embodiment, interview system 120 is located in an interview room used to interview an offender while verification management system 110 is located in a separate room. In an embodiment, interview system 120 is a mobile system that is transported while verification management system is located in a location remote from interview system 120. For example, a law enforcement agent and/or a pre-trial service administrator may travel to the location of the offender while verification management system remains in a fixed location, such as, for example, at a police station and/or the pre-trial service administrator's office.

In an embodiment interview system 120 operates in a similar fashion as described with reference to FIG. 1A. Interview system 120 utilizes microphone 122A and camera 122B to record responses provided by an offender. Interview system 120 utilizes speaker 122C and/or display screen 122D to provide audio information to the offender and/or the interviewer. In an embodiment, interview system 120 also includes one or more processors, memory, servers, routers, modems, antennae, and/or circuitry configured to interface with microphone 122A, camera 122B, speaker 122C, display screen 122D, hardware configuration system 130A, and/or verification management system 110.

In an embodiment, interview system 120 provides voice prompt menus to interview the offender via speaker 122C. Display screen 122D also displays menus and/or questions asked. Microphone 122A records audio responses spoken by the offender. Camera 122B captures images of the offender and/or captures video of the offender while interviewed.

In an embodiment, the offender may provide audio information that verification management system 110 records and utilizes to populate a report of the interview. Verification management system 110 also analyzes visual information provide by camera 122B, such as handwriting and/or drawings using optical character recognition and/or image processing algorithms.

In an embodiment, hardware configuration system 130A is a component of interview system 120 and interfaces with mobile communication device 132. In an embodiment where interview system 120 is remote from verification management system 110 but in proximity to the offender, a law enforcement agent and/or a pre-trial service administration connects mobile communication device 132 to hardware configuration system 130A while mobile communication device 132 remains in the presence of the offender. In an embodiment described with reference to FIG. 1A, mobile communication device 132 connects to hardware configuration system 130, which is remote from the location where the offender is interviewed.

Under the configuration where mobile communication device 132 is located in proximity to the offender, the offender may be more willing to provide consent to accessing the content stored on mobile communication device 132. This configuration allows the offender to visually monitor mobile communication device 132. This configuration also allows the offender to provide instructions to potentially access content on mobile communication device 132. The connection of mobile communication device 132 to interview system 120 allows verification management system 110 to access content on mobile communication device 132 in a manner similar to the manner described with reference to FIG. 1A. Based on this access, interview system 120 and/or verification management system 110 verifies if responses provided by the offender are confirmed by mobile communication device 132 and/or if information contained in mobile communication device 132 contradicts an offender's response.

Similar to the embodiment described with reference to FIG. 1A, verification management system 110 also utilizes network 140 to interface with jurisdictional database 150 as another source of verification information. Based on the offender responses provided to interview system 120, verification management system 110 verifies the accuracy of the response using information from jurisdictional database 150.

FIG. 1C illustrates a block diagram of a hardware configuration system 130, according to exemplary embodiments. Hardware configuration system 130 may be utilized in a manner similar to the methods described with reference to FIG. 1A and FIG. 1B. In an embodiment, hardware configuration system 130 includes, a central processing unit (CPU) 131, memory 133, mobile communication device interface 135, offender peripheral device interface 137, and verification management system interface 139.

In an embodiment, CPU 131 includes one or more processors configured to communicatively connect with mobile communication device interface 135, offender peripheral device interface 137, and/or verification management system interface 139. CPU 131 also interfaces with memory 133 to store information received at hardware configuration system 130. In an embodiment, memory 133 includes a memory device, such as, for example, volatile memory, non-volatile memory, a hard disk drive, a solid-state memory device, a database, and/or virtual data storage. In an embodiment, memory 133 includes remote data storage capabilities. CPU 131 also retrieves data stored in memory 133 for transmission out of hardware configuration system 130 via mobile communication device interface 135, offender peripheral device interface 137, and/or verification management system interface 139.

Mobile communication device interface 135 is a connector used to allow communication between CPU 131 and a mobile communication device 132. For example, in an embodiment, mobile communication device interface 135 includes wired connectors, such as, for example, a Universal Serial Bus, Ethernet, and/or a coaxial connector, and/or wireless connectors, such as, for example, a Bluetooth® and/or other radio frequency transceiver.

Using mobile communication device interface 135, CPU 131 accesses content stored in mobile communication device 132. As described with reference to FIG. 1A and FIG. 1B, the offender may provide consent to scan the content of mobile communication device 132. In an embodiment, CPU 131 creates a copy of the content of mobile communication device 132 and stores this content locally in memory 133. In an embodiment, verification management system 110 accesses data stored in memory 133 using verification management system interface 139. In an embodiment, management system interface 139 includes wired and/or wireless connectors to provide a communication connection between verification management system 110 and hardware configuration system 130. In an embodiment, hardware configuration system 130 is a component of verification management system 110 as an integrated system, sharing hardware with verification management system 110. Verification management system 110 accesses content from mobile communication device 132 to perform verification of responses provided by an offender during an interview.

In an embodiment, hardware configuration system 130 operates without a verification management system interface 139. Hardware configuration system 130 utilizes mobile communication device interface 135 to modify content on mobile communication device 132. For example, CPU 131 modifies and/or restricts certain features of mobile communication device 132 via mobile communication device interface 135.

For example, the judiciary may decide to release an offender until trial. In some instances, the judiciary may require a bond. In some cases, the judiciary imposes conditions and/or restrictions on the offender. For example, the judiciary may generate restrictions based on geography (e.g., the offender may not enter a geographic location and/or the offender is restricted to only certain locations), maintaining a curfew, and/or requiring regular drug testing. The judiciary may also impose status quo conditions, such as, for example, requiring that an offender maintain his or her residence, school, and/or employment status. The conditions may be problem-oriented and may address specific offender problems that may affect future court appearances and/or future arrests. These conditions may require an offender to, for example, enroll in a substance abuse monitoring and/or treatment, vocational and/or educational training, counseling, and/or other social service programs. The judiciary may impose a contact requirement, requiring an offender to regularly report, by telephone and/or in person, to a law enforcement agent and/or a pre-trial service administrator. The judiciary may impose a restrictive condition, limiting an offender's associations, movements, and/or actions. A restrictive condition may include requiring an offender to remain within a jurisdiction until trial, avoiding contact with a complainant, victim, and/or witness, adhering to a curfew, and/or avoiding geographic locations, such as, for example, locations where drug sales are common.

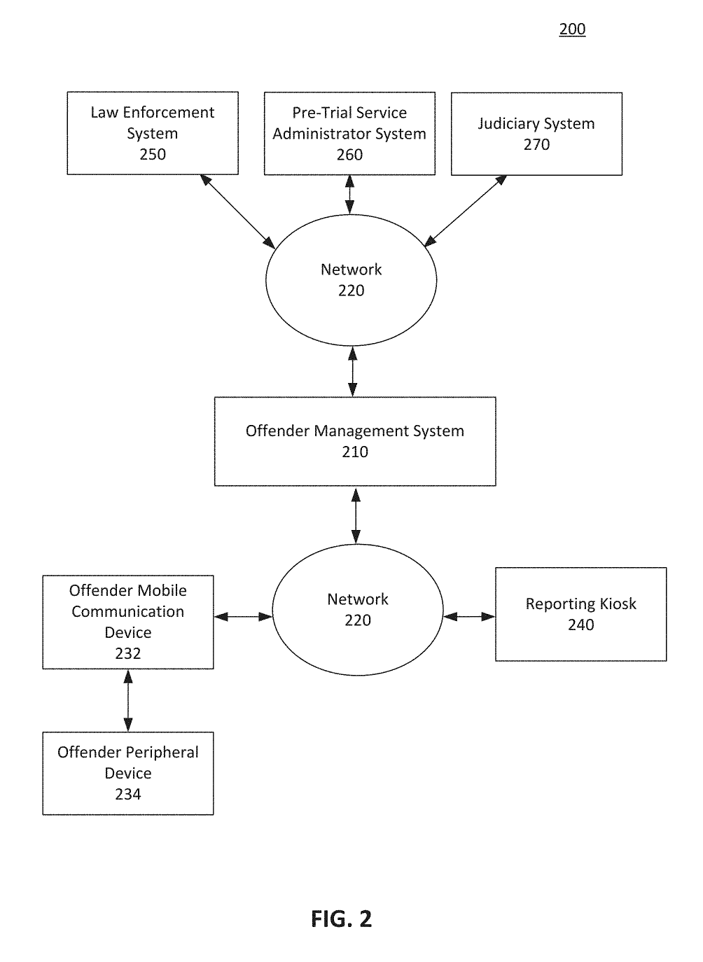

To encourage adherence to these conditions, in some embodiments, hardware configuration system 130 may modify the offender's mobile communication device 132 with consent from the offender. For example, hardware configuration system 130 modifies the GPS functionality of a mobile communication device 132 to monitor the location of the offender. Similarly, hardware configuration system 130 modifies mobile communication device 132 to monitor offender phone calls, initiated and/or received by the offender. This monitoring aspect is further described with respect to FIG. 2.

In an embodiment, hardware configuration system 130 also installs software allowing an offender to access substance abuse counseling and/or training material to educate the offender. In an embodiment, hardware configuration system 130 installs tests on mobile device 132 to ensure that the offender gains awareness of the issues requiring treatment. Hardware configuration system 130 delivers educational course work to mobile communication device 132, allowing an offender to further his or her vocational knowledge. In an embodiment, hardware configuration system 130 configures mobile communication device 132 to provide assistance from social service and/or counseling services. In an embodiment, hardware configuration system 130 configures mobile communication device 132 to interface with an offender peripheral device 134.

In an embodiment, offender peripheral device 134 is a device useful for monitoring statistics related to the offender. For example, in an embodiment, in an embodiment, offender peripheral device 134 monitors biological statistics and/or geographic statistics. In an embodiment, offender peripheral device 134 includes one or more processors, memory, antennae, cameras, biometric sensors, and/or circuitry configured to monitor statistics related to an inventor and/or communicate the monitored statistics. In an embodiment, offender peripheral device 134 interfaces with mobile communication device 132. In an embodiment, offender peripheral device 134 includes a separate communication feature. In an embodiment, offender peripheral device 134 interfaces with hardware configuration system 130 using offender peripheral device interface 137. Offender peripheral device interface 137 is a connector used to allow communication between CPU 131 and an offender peripheral device 134. For example, in an embodiment, offender peripheral device interface 137 includes wired connectors, such as, for example, a Universal Serial Bus, Ethernet, and/or a coaxial connector, and/or wireless connectors, such as, for example, a Bluetooth® and/or other radio frequency transceiver.

In an embodiment, the judiciary requires the offender to relinquish the offender's mobile communication device 132 and issue a new, law enforcement-issued offender peripheral device 134 to the offender pending trial. In this embodiment, hardware configuration system 130 configures the law enforcement-issued offender peripheral device 134 with certain features. For example, hardware configuration system 130 configures offender peripheral device 134 to receive phone calls intended for the offender's mobile communication device 132. In an embodiment, hardware configuration system 130 copies some information, such as, for example, contacts, from the offender's mobile communication device 132 onto the law enforcement-issued offender peripheral device 134.

In an embodiment, offender peripheral device 134 is a device that communicates with an offender's mobile communication device. For example, offender peripheral device 134 is a breathalyzer configured to interface with mobile communication device 132. Offender peripheral device 134 is a device capable of connecting to mobile communication device 132 or is a standalone device. In an embodiment, offender peripheral device 134 gathers information related to the information and utilize mobile communication device 132 to transmit the gathered information to a remote judiciary database. In an embodiment, this gathering alerts a law enforce agency, a pre-trial service administrator, and/or the judiciary of potential violations of release conditions.

In an embodiment, offender peripheral device 134 is a wearable device, such as, for example, a device semi-permanently attachable to an offender's wrist or ankle. In an embodiment, wearable offender peripheral device 134 communicates with the offender's mobile communication device 132 and/or directly with an offender management system described in further detail with respect to FIG. 2.

In an embodiment, an offender management system requires wearable offender peripheral device 134 to be in close proximity to the offender's mobile communication device 132, preventing the offender from relinquishing control of the offender's mobile communication device 132.

In an embodiment, offender peripheral device 134 includes a biometric sensor. In an embodiment, the biometric sensor is configured to detect low concentrations of alcohol secreted through the skin and determine how much alcohol has been consumed. Offender peripheral device 134 and/or the offender's mobile communication device 132 reports results over a certain threshold to an offender management system.

In an embodiment, offender peripheral device 134 is an electronic device inserted just below the surface of the skin. The subcutaneous offender peripheral device 134 provides continuous sampling and diagnostics related to substance abuse. In an embodiment, mobile communication device 132 interfaces with the subcutaneous offender peripheral device 134 and reports measurements associated with the offender's biological state to an offender management system. Combining the functionality of mobile communication device 132 with offender peripheral device 134 better informs the judiciary regarding compliance with release conditions and further encourages offenders to adhere to the conditions.

FIG. 2 illustrates a block diagram of an offender notification and monitoring system 200, according to exemplary embodiments. In an embodiment, offender notification and monitoring system 200 includes an offender management system 210, network 220, offender mobile communication device 232, offender peripheral device 234, reporting kiosk 240, law enforcement system 250, pre-trial service administrator system 260, and judiciary system 270. In an embodiment, offender management system 210 interfaces with an offender mobile communication device 232 via network 220 to monitor information regarding an offender. In an embodiment, offender management system 210 transmits information collected from an offender mobile communication device 232 and/or reporting kiosk 240 to law enforcement system 250, pre-trial service administrator system 260, and/or judiciary system 270.

In an embodiment, offender management system 210 includes one or more processors, memory, servers, routers, modems, antennae, and/or circuitry configured to interface with network 220 to interface with offender mobile communication device 232, offender peripheral device 234, reporting kiosk 240, law enforcement system 250, pre-trial service administrator system 260, and/or judiciary system 270. In an embodiment, network 220 is a network capable of transmitting information either in a wired or wireless manner and may be, for example, the Internet, a Local Area Network, or a Wide Area Network. In an embodiment, offender management system 210 utilizes a network protocol, such as, for example, a hypertext transfer protocol (HTTP), a TCP/IP protocol, Ethernet, cellular, Bluetooth, or an asynchronous transfer mode, to name just a few examples, or any combination thereof.

Similar to the monitoring features described with reference to FIG. 1C, in an embodiment, offender management system 210 receives information from an offender mobile communication device 232. Offender management system 210 monitors offenders who have opted to participate in release monitoring. Offender management system 210 receives information such as, for example, global position system (GPS) information from an offender mobile communication device 232. In an embodiment, with the consent of the offender, offender management system 210 listens to phone calls or audio information from offender mobile communication device 232. For example, when an offender participates in a telephone conversation, offender management system 210, records the conversation and/or portions of the conversation as an audio file. In an embodiment, offender management system 210 transfers the audio file to law enforcement system 250, pre-trial service administrator system 260, and/or judiciary system 270. In an embodiment, offender mobile communication device 232 alerts offender management system 210 of a live call, allowing a law-enforcement agent and/or a pre-trial service administrator to listen to the call in a live manner. In an embodiment, offender management system 210 restricts certain features of offender mobile communication device 232, such as, for example, the ability to call or to be called by specified parties using offender mobile communication device 232. While this restriction may not completely prevent communications with blocked parties, impeding phone calls using the mobile communication device may deter some calls from occurring.

In an embodiment, offender management system 210 receives data from offender peripheral device 234. Offender peripheral device 234 includes one or more biometric sensors configured to measure biometric data relative to the offender. Similar to the monitoring features described with reference to FIG. 1C, offender management system 210 receives information directly from information transmitted from offender peripheral device 234 to network 220 and/or receives information from data transmitted from offender peripheral device 234 to offender mobile communication device 232. Information gathered from offender mobile communication device 232 and/or offender peripheral device 234 includes biometric information, such as, for example, images from a camera for facial recognition purposes, voice biometric, fingerprint scans, and/or measurements related to alcohol and/or drug usage. In an embodiment, offender management system 210 collects this information and determine if the offender has violated a release condition.

In an embodiment, the conditions are stored in a database in offender management system 210 and the offender management system 210 compares the received data with the information stored to determine if a violation has occurred. In an embodiment, if offender management system 210 has determined that an offender has violated a release condition, offender management system 210 sends a notification to law enforcement system 250, pre-trial service administrator system 260, and/or judiciary system 270. This feature allows for appropriate action to be taken. In an embodiment, this configuration also informs law enforcement system 250, pre-trial service administrator system 260, and/or judiciary system 270 of any potential subsequent arrests of the offender. In an embodiment, offender management system 210 also recommends modifications of release conditions when appropriate, maintain a record of the offender's compliance with release conditions, and/or assist offenders released in securing employment and in obtaining medical services, drug or mental health treatment, legal services, and/or other social services that may increase the chances of successful compliance with pre-trial release conditions.

In an embodiment, offender management system 210 transmits information to an offender mobile communication device 232. For example, offender management system 210 transmits notifications regarding required “check-ins,” potential violations of release conditions, court dates, and/or other information that may aid the offender in adhering to release conditions.

In an embodiment, offender management system 210 periodically sends “check-in” notifications to offender mobile communication device 232. For example, offender management system 210 requires offender mobile communication device 232 and/or offender peripheral device 234 to return information for verification that the offender still maintains possession of offender mobile communication device 232 and/or offender peripheral device 234. In an embodiment, offender management system 210 requires that the offender provide a biometric features associated with a biometric sensor of offender mobile communication device 232 and/or offender peripheral device 234 to verify the identity of the offender. For example, offender management system 210 requires an image showing the offender's face, an offender voiceprint, and/or a breathalyzer sample. Based on these check-in requirements, offender management system 210 verifies that the offender is still in possession of offender mobile communication device 232 and confirms that a GPS location corresponding to offender mobile communication device 232 correctly corresponds to the offender location. In an embodiment, “check-in” notifications sent from offender management system 210 are scheduled, informing the offender in advance. In an embodiment, “check-in” notifications are randomly generated and sent to offender mobile communication device 232. This check-in requirement is unannounced and provides the offender with a preset amount of time in which the offender must respond. If the offender does not respond within the preset amount of time, in an embodiment, offender management system 210 generates an alert and/or inform the judiciary of the noncompliance.

In an embodiment, offender management system 210 sets exclusions zones where an offender may not enter. These exclusion zones correspond to areas restricted by the judiciary as part of the offender's release conditions. In an embodiment, these exclusion zones correspond to fixed geographic locations. If an offender and/or offender mobile communication device 232 falls within and/or nears the exclusion zone, offender management system 210 sends an alert to offender mobile communication device 232. The alert indicates that the offender may potentially violate a release condition by entering an exclusion zone.

In an embodiment, an exclusion zone are mobile. In an embodiment, an exclusion zone surrounds an individual that the offender may not approach. In an embodiment, offender management system 210 also interfaces with mobile devices in possession of individuals other than the offender. For example, if a release condition prevents an offender from approaching a witness and/or a victim, offender management system 210 interfaces with a mobile device owned by a witness and/or a victim. In this case, when offender management system 210 detects that offender mobile communication device 232 is in the vicinity of the witness and/or victim, offender management system 210 notes non-compliance with the release condition. To detect this vicinity, offender management system 210 calculates the distance between the offender mobile communication device 232 and the mobile device owned by the witness and/or victim. When the distance between the two devices falls below a threshold, offender management system 210 notes non-compliance with the release condition. In an embodiment, offender management system 210 notifies the witness, victim, law enforcement agent, pre-trial service administrator, and/or the judiciary when offender management system 210 notices non-compliance. This embodiment provides protection to particular individuals that the offender may be restricted from approaching.

In an embodiment, offender management system 210 sends notifications to offender mobile communication device 232. For example, offender management system 210 sends court date reminders to offender mobile communication device 232. In an embodiment, offender management system 210 sends a court date reminder via an electronic message, such as, for example, an e-mail and/or text message. In an embodiment, offender management system 210 sends an audio message. In an embodiment, offender management system 210 sends a message but also requires that the offender first provide biometric identification before opening the message. For example, when sending an audio message, offender management system 210 requires that the offender supply biometric voice identification to ensure that the person receiving the telephoned court data reminder is indeed the offender. This embodiment removes doubt concerning whether the offender received the message.

In an embodiment, offender management system 210 interfaces with reporting kiosk 240 using network 220. In an embodiment, reporting kiosk 240 replaces in-person reporting requirements. Reporting kiosk 240 includes one or more processors, memory, antennae, servers, routers, modems, computer input peripherals, a keyboard, a mouse, cameras, microphones, biometric sensors, and/or circuitry configured to verify the identity of the offender and/or communicate with offender management system 210. In an embodiment, an offender utilizes reporting kiosk 240 to adhere to release conditions.

For example, reporting kiosk 240 utilizes biometric technology, such as fingerprint scanning, facial recognition, iris scanning, and/or voice biometrics to confirm the identity of the offender. In an embodiment, the offender inputs log-in information and/or biometric information to confirm the offender's identity. The offender also inputs information regarding any changes in status relative to the most recent information recorded. For example, the offender updates offender management system 210 with a new addresses, employment status, marital status, and/or contact with law enforcement agents. In an embodiment, reporting kiosk 240 interfaces with an information evaluation system similar to those described in FIG. 1A and FIG. 1B to verify information provided. In an embodiment, reporting kiosk 240 integrates a hardware configuration system as described with reference to FIG. 1C. This integration allows for configuration of the offender mobile communication device 232 and/or the offender peripheral device 234. In an embodiment, reporting kiosk 240 allows for automated offender check-ins. This embodiment more quickly services offenders and saves the time of law enforcement agents and/or pre-trial service administrators.

In an embodiment, if an offender fails to report to reporting kiosk 240 as required, reporting kiosk 240 sends a message to offender management system 210. Offender management system 210 then sends a message to a supervising law enforcement agent and/or pre-trial service administrator. In an embodiment, offender management system 210 sends a reminder to offender mobile communication device 232. Reporting kiosk 240 also initiates other messages to the offender, such as, for example, a notification to report for a drug test.

In an embodiment, reporting kiosk 240 is located in a public location accessible to offenders. Reporting kiosk 240 operates outside normal business hours, allowing offenders who are employed to fulfill their employment commitments.

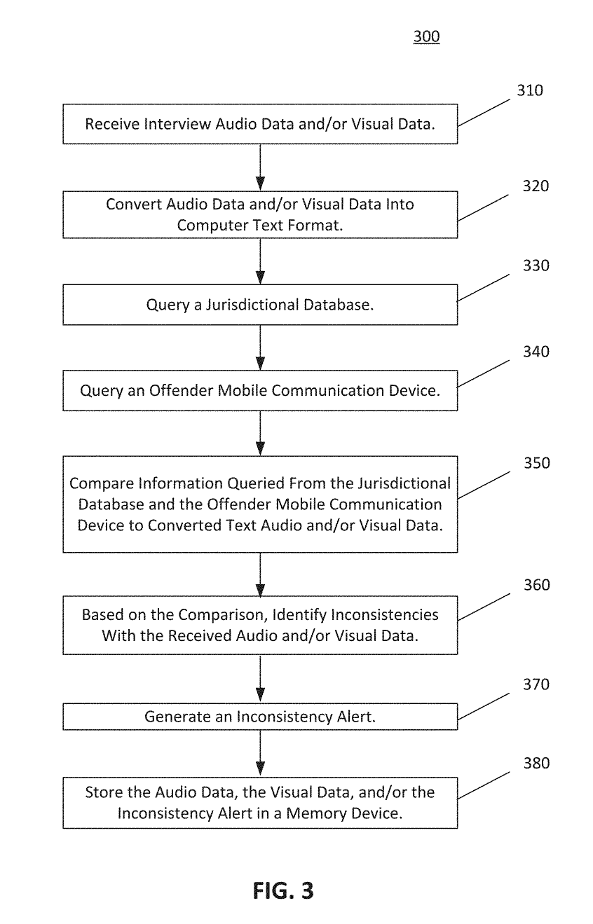

FIG. 3 illustrates a flowchart illustrating a method 300 for real-time interview verification, according to exemplary embodiments. Method 300 shall be described with reference to FIG. 1A and FIG. 1B; however, method 300 is not limited to that example embodiment.

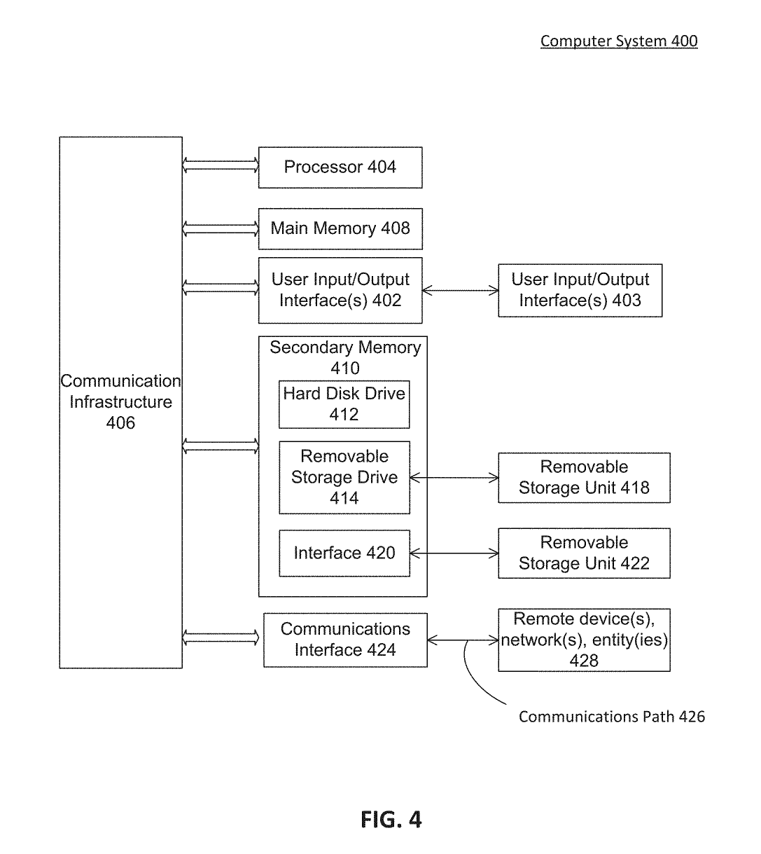

In an embodiment, verification management system 110 utilizes method 300 to determine if an offender has provided an inconsistent statement. The foregoing description will describe an embodiment of the execution of method 300 with respect to verification management system 110. While method 300 is described with reference to information evaluation system 100, method 300 may be executed on any computing device, such as, for example, the computer system described with reference to FIG. 4 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 3, as will be understood by a person of ordinary skill in the art.

In an embodiment, at 310, verification management system 110 receives interview audio data and/or visual data. In an embodiment, interview system 120 captures interview audio data via a microphone and/or captures visual data via a camera.

In an embodiment, at 320, verification management system 110 converts the audio data and/or visual data into computer text format. Verification management system 110 converts the audio information into a text format using speech-to-text signal processing. In an embodiment, verification management system 110 converts the audio information provided by the offender into text for report generation. For example, the offender may provide audio information that verification management system 110 populates in a report of the interview. Verification management system 110 also analyzes visual information, such as handwriting and/or drawings using optical character recognition and/or image processing algorithms.

In an embodiment, at 330, verification management system 110 queries a jurisdictional database. Verification management system 110 determines the type of information to be queried based on the information converted audio and/or visual data into computer text format. Verification management system 110 compares the results retrieved to verify information provided by the offender. For example, the offender may state that he has not been arrested within the past year. Querying a jurisdictional database, however, may indicate that the offender was arrested six months ago, thus, disproving the offender's statement.

In an embodiment, at 340, verification management system 110 queries an offender mobile communication device. In an embodiment, a law enforcement agent and/or a pre-trial services administrator first obtains consent from the offender before querying the offender's mobile communication device. Based on responses provided by the offender, verification management system 110 targets information related to the offender's response to verify or disprove the offender's statement. For example, if the offender states that the offender does not know a specific individual, but the individual's phone number is stored on the offender's mobile communication device, verification management system 110 will recognize the discrepancy. In this case, the offender's response may be disproved.

In an embodiment, verification management system 110 queries an offender mobile communication device while restricting access to the information by a law enforcement agent and/or a pre-trial service administrator. In this embodiment, the information and/or content stored in the offender mobile communication device remains remain confidential.

In an embodiment, at 350, verification management system 110 compares the information queried from the jurisdictional database and the offender mobile communication device to the converted text audio and/or visual data. Based on the format of the received audio and/or visual data, the conversion at 320 allows for this comparison at 350 to occur. In an embodiment, in addition to audio responses, items written or drawn by the offender are compared with jurisdictional database information and/or offender mobile communication device information.

In an embodiment, at 360, based on the comparison, verification management system 110 identifies inconsistencies between the queried data and the received audio and/or visual data. In an embodiment, the comparison and identification occurs in real-time as the interview is being conducted. In an embodiment, multiple response are be compared and multiple inconsistencies may be identified.

In an embodiment, at 370, verification management system 110 generates an inconsistency alert. In an embodiment, verification management system 110 logs the inconsistency alert in a report, generates a risk assessment score utilizing the inconsistency alert, displays the alert visually, and/or generates an audio cue to indicate that an inconsistency has been detected. An interviewer may then determine an appropriate course of action and/or may adjust the line of questioning. In an embodiment where a voice menu prompt is utilized, the voice menu questions change based on the detection of inconsistent statements.

In an embodiment, at 380, verification management system 110 stores the audio data, visual data, and inconsistency alert in a memory device. In an embodiment, verification management system 110 stores the audio data, visual data, and/or inconsistency alert in a memory device local within the verification management system 110. In an embodiment, verification management system 110 stores the audio data, visual data, and/or inconsistency alert in a remote database, such as, for example, a law enforcement system, pre-trial service administrator system, and/or judiciary system.

In an embodiment, verification management system 110 does not store certain audio data, visual data, and/or an inconsistency alert. For example, if privacy concerning data stored on an offender mobile communication device must be maintained, verification management system 110 does not store the content from offender mobile communication device. Instead, verification management system 110 deletes this information after the interview has completed.

In an embodiment, based on the inconsistencies identify and based on other information gathered during the interview, including information from a jurisdictional database and/or the offender mobile communication device, verification management system 110 generates a risk assessment score. Verification management system 110 also generates a report of the inconsistent statements, potentially providing proof of inconsistency, and/or a recommendation as to whether the offender should be released or incarcerated pending trial. In an embodiment, verification management system 110 also recommends certain conditions to be imposed if the offender is released. In an embodiment, these conditions are determined from a list of judicially approved conditions.

Referring now to FIG. 4, various embodiments may be implemented, for example, using one or more computer systems, such as computer system 400 shown in FIG. 4. One or more computer systems 400 (or portions thereof) can be used, for example, to implement method 300 of FIG. 3.

Computer system 400 can be any well-known computer capable of performing the functions described herein.

Computer system 400 includes one or more processors (also called central processing units, or CPUs), such as a processor 404. Processor 404 is connected to a communication infrastructure or bus 406.

One or more processors 404 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 also includes user input/output device(s) 403, such as monitors, keyboards, pointing devices, etc., that communicate with communication infrastructure 406 through user input/output interface(s) 402.

Computer system 400 also includes a main or primary memory 408, such as random access memory (RAM). Main memory 408 may include one or more levels of cache. Main memory 408 has stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 includes a computer usable or readable storage device having stored thereon computer software (control logic) and/or data. Removable storage unit 418 may be a floppy disk, magnetic tape, compact disk, DVD, optical storage disk, and/any other computer data storage device. Removable storage drive 414 reads from and/or writes to removable storage unit 418 in a well-known manner.

According to an exemplary embodiment, secondary memory 410 may include other means, instrumentalities or other approaches for allowing computer programs and/or other instructions and/or data to be accessed by computer system 400. Such means, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 enables computer system 400 to communicate and interact with any combination of remote devices, remote networks, remote entities, etc. (individually and collectively referenced by reference number 428). For example, communication interface 424 may allow computer system 400 to communicate with remote devices 428 over communication path 426, which may be wired and/or wireless, and which may include any combination of LANs, WANs, the Internet, etc. Control logic and/or data may be transmitted to and from computer system 400 via communication path 426.

In an embodiment, a tangible apparatus or article of manufacture comprising a tangible computer useable or readable medium having control logic (software) stored thereon is also referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), causes such data processing devices to operate as described herein.

Based on the teachings contained in this disclosure, it will be apparent to persons skilled in the relevant art(s) how to make and use embodiments using data processing devices, computer systems and/or computer architectures other than that shown in FIG. 4. In particular, embodiments may operate with software, hardware, and/or operating system implementations other than those described herein.

It is to be appreciated that the Detailed Description section, and not the Abstract section, is intended to be used to interpret the claims. The Abstract section may set forth one or more but not all exemplary embodiments as contemplated by the inventor(s), and thus, are not intended to limit the disclosure or the appended claims in any way.

While the disclosure has been described herein with reference to exemplary embodiments for exemplary fields and applications, it should be understood that the scope of the disclosure is not limited thereto. Other embodiments and modifications thereto are possible, and are within the scope and spirit of the disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of disclosed inventions should not be limited by any of the above-described exemplary embodiments, but should be defined only in accordance with the following claims and their equivalents.

1. A computer-implemented method, comprising:
recording first audio data during a first interview with an offender;
converting the first audio data into a textual form to produce first textual interview data;
storing the first textual interview data in a criminal history database;
recording second audio data during a second interview with the offender;
converting the second audio data into a textual form to produce second textual interview data;
identifying keywords from the second textual interview data;
querying the criminal history database using the keywords to fetch the first textual interview data;
comparing the keywords with the first textual interview data;
determining that the keywords differ from the first textual interview data based on the comparing; and
in response to determining that the keywords differ from the first textual interview data, generating a criminal history record discrepancy notification.

2. The computer-implemented method of claim 1, further comprising:
retrieving mobile communication device data stored on a mobile communication device;
comparing the keywords with the mobile communication device data;
determining that the keywords differ from the mobile communication device data based on the comparing; and
in response to determining that the keywords differ from the mobile communication device data, generating a mobile communication device discrepancy notification.

3. The computer-implemented method of claim 1, further comprising:
converting one or more images captured during the second interview into a textual form to produce optically generated text;
comparing the optically generated text with the keywords;
determining that the optically generated text differs from the keywords based on the comparing; and
in response to determining that the optically generated text differs from the keywords, generating a second criminal history record discrepancy notification.

4. The computer-implemented method of claim 1, further comprising:
generating an incarceration recommendation based on the comparing of the keywords with the first textual interview data.

5. The computer-implemented method of claim 1, further comprising:
playing an interactive voice prompt menu, wherein the interactive voice prompt menu requests the first or second audio data to be recorded.

6. The computer-implemented method of claim 1, wherein the converting of the first or second audio data into a textual form further comprises translating content of the first or second audio data from a first language to a second language.

7. The computer-implemented method of claim 1, further comprising:
storing the second textual interview data in the criminal history database; and
linking the second textual interview data to the first textual interview data.

8. An information evaluation system, comprising:
a microphone that records audio interview information;
one or more processors and/or circuits coupled to the microphone, wherein the one or more processors and/or circuits are configured to:
record audio information from a first party via the microphone;
retrieve, from a contact list stored on a mobile communication device secured by the first party, contact information identifying a verifier communication device, wherein the contact information indicates that the verifier communication device belongs to a second party that differs from the first party;
generate an automated voice call menu to the verifier communication device by utilizing the contact information to request verification information from the second party via the verifier communication device;
compare the verification information with the audio information;
determine that the audio information differs from the verification information based on the comparing; and
in response to determining that the audio information differs from the verification information, generating a discrepancy notification.

9. The information evaluation system of claim 8, wherein the contact information is a phone number and the one or more processors and/or circuits are further configured to initialize a phone call with the verifier communication device using the phone number.

10. The information evaluation system of claim 8, wherein to request verification information from the verifier communication device, the one or more processors and/or circuits are further configured to play an interactive voice prompt menu, wherein the interactive voice prompt menu requests the verification information.

11. The information evaluation system of claim 8, further comprising a camera coupled to the one or more processors, and wherein the one or more processors and/or circuits are further configured to:
convert one or more images captured by the camera into a textual form to produce optically generated text;
compare the optically generated text to the verification information; and
determine whether the optically generated text matches the verification information.

12. The information evaluation system of claim 11, wherein the one or more processors and/or circuits are further configured to:
record a video via the camera; and
store the video in a criminal history database.

13. The information evaluation system of claim 8, wherein to compare the audio information with the verification information, the one or more processors and/or circuits are further configured to translate the received audio information to a language comparable to the verification information.

14.-27. (canceled)

28. A system, comprising:
a criminal history database; and
one or more processors and/or circuits coupled to the criminal history database, wherein the one or more processors and/or circuits are configured to:
record first audio data during a first interview with an offender;
convert the first audio data into a binary form to produce first binary vector data;
store the first binary vector in the criminal history database;
record second audio data during a second interview with the offender;
convert the second audio data into a binary form to produce second binary vector data;
identify keywords from the second binary vector data;
query the criminal history database to fetch the first binary vector data;
compare the keywords with the first binary vector data;
determine that the keywords differ from the first binary vector data based on the comparing; and
in response to determining that the keywords differ from the first binary vector data, generating a criminal history record discrepancy notification.

29. The system of claim 28, the one or more processors and/or circuits further configured to:
retrieve mobile communication device data stored on a mobile communication device;
compare the keywords with the mobile communication device data;
determine that the keywords differ from the mobile communication device data based on the comparing; and
in response to determining that the keywords differ from the mobile communication device data, generate a mobile communication device discrepancy notification.

30. The system of claim 28, the one or more processors and/or circuits further configured to:
convert one or more images captured during the second interview into a textual form to produce optically generated text;
compare the optically generated text with the keywords;
determine that the optically generated text differs from the keywords based on the comparing; and
in response to determining that the optically generated text differs from the keywords, generate a second criminal history record discrepancy notification.

31. The system of claim 28, the one or more processors and/or circuits further configured to:
generate an incarceration recommendation based on the comparing of the keywords with the first binary vector data.

32. The system of claim 28, the one or more processors and/or circuits further configured to:
play an interactive voice prompt menu, wherein the interactive voice prompt menu requests the first or second audio data to be recorded.

33. The system of claim 28, wherein the converting of the first or second audio data into a binary form further comprises translating content of the first or second audio data from a first language to a second language.

34. The system of claim 28, the one or more processors and/or circuits further configured to:
store the second binary vector data in the criminal history database; and
link the second binary vector data to the first binary vector data.
